(19) United States
(12) Patent Application Publication
(10) Pub. No.: US 2006/0007080 A1
(43) Pub. Date: Jan. 12, 2006

(54) Apparatus and method for improving image-sticking effect of liquid crystal display

(76) Inventor: Liang-Hua Yeh, San Chung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/884,894

(22) Filed: Jul. 6, 2004

(51) Int. Cl. G09G 3/36

(52) U.S. Cl. 345/87

(57) ABSTRACT

An apparatus for improving an image-sticking effect of a liquid crystal display is described. The apparatus has a comparator, a counter connected to the comparator, and an inset device connected to the counter. When receiving an image datum, the comparator first compares the image datum with a previous image datum stored in an image memory to determine whether the image datum is a still image or not. If the image datum is not a still image, the image datum is directly transmitted to an image output device. On the contrary, if the image datum is a still image, a value of the counter is then increased. An inset image is produced by the inset device and is transmitted to the image output device when the value equals a threshold value. As a result, the image-sticking effect is reduced because an image that is still for a long period is forced to change.

### FIELD OF THE INVENTION

The present invention relates to a method and an apparatus for improving the image-sticking effect of a display, and more particularly, to a method and an apparatus for improving the image-sticking effect of a liquid crystal display.

### BACKGROUND OF THE INVENTION

Opto-electronics technologies have recently progressed by leaps and bounds due to the coming of the digital era, which also has stimulated the market for liquid crystal displays (LCDs). The liquid crystal displays possess many advantages, such as, for example, high display quality, small volume occupation, light weight, low driving voltage, and low power consumption. Therefore, the liquid crystal displays are gradually replacing conventional cathode ray tube (CRT) displays and are applied widely to 3C (computers, communications, and consumer electronic) products, for example, personal digital assistants (PDAs), cellular phones, video recording units, notebook computers, desktop monitors, vehicular monitors, and projective televisions.

So far, the liquid crystal displays are usually used by alternating current (AC) driving method. The liquid crystal displays further reverse the polarity of a voltage applied to a liquid crystal cell every frame time, in order to reduce the driving voltage of the liquid crystal displays. FIG. 1 illustrates a conventional pixel cell of a thin film transistor (TFT) liquid crystal display. The conventional pixel cell includes a thin film transistor 120 having a gate connected to a scanning line 110 and a source connected to a data line 130, as well as a liquid crystal cell 160 connected among a drain of the thin film transistor 120, an auxiliary capacitor 180 and a common voltage source (V_{com}), as shown in FIG. 1. The thin film transistor 120 is selectively turned on by controlling the scanning line 110 to connect the data line 130. When the thin film transistor 120 is turned on, the liquid crystal cell 160 and the auxiliary capacitor 180 accumulate a signal voltage from the data line 130 and maintain the accumulated signal voltage until the thin film transistor 120 is turned on again. However, the voltages of liquid crystal cells in a liquid crystal display are not identical, which incurs different gate voltages for each scanning line. As a result, the polarities of the positive voltage and the negative voltage applied to the liquid crystal cell 160 have different absolute values with respect to each other. Hence, a certain amount of direct-current (DC) charges accumulate in the liquid crystal cell 160. Consequently, a residual image caused by the accumulated DC charges is displayed on a panel of the liquid crystal display when changing a displayed picture; especially the displayed picture is at a still status for a long time.

### SUMMARY OF THE INVENTION

It is the objective of the present invention to provide a method and an apparatus for improving the image-sticking effect of a liquid crystal display resulting from a still image appearing on a panel of the liquid crystal display for a period of time.

According to the aforementioned objective of the present invention, an apparatus for improving the image-sticking effect of a liquid crystal display is provided. The apparatus recognizes the state of an image displayed on a panel of the liquid crystal display and then forces image to vary when detecting a still image state.

According to the aforementioned objective of the present invention, on the other hand, a method for improving the image-sticking effect of a liquid crystal display is provided. The image-sticking effect caused by DC charges is diminished through altering an image displayed on a panel, especially when the displayed image is still on the panel for a long period of time.

In accordance with a preferred embodiment of the present invention, a comparator first analyzes an image datum and determines whether it's a still image or not after receiving it. If a still image is detected, a value of a counter is then increased. An inset image is next produced by an inset device and is transmitted to a panel of a liquid crystal display when the value of the counter successively accumulates to a threshold value. Therefore, a still image appearing on the panel of the liquid crystal display is changed by displaying the inset image, so as to reduce the image-sticking effect of the liquid crystal display.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 illustrates a conventional pixel cell of a thin film transistor liquid crystal display;

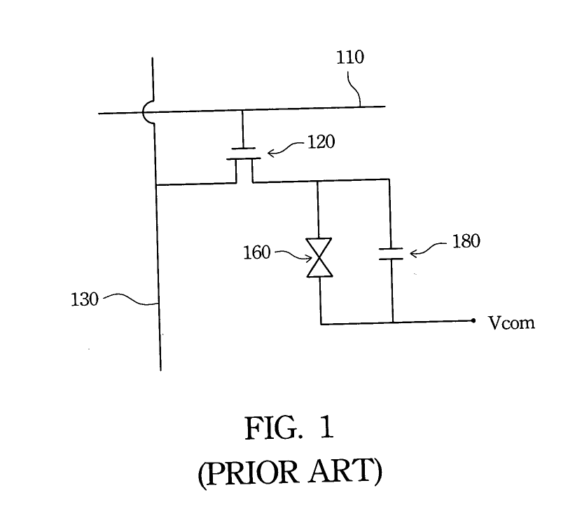

FIG. 2 illustrates a block diagram of an apparatus for improving the image-sticking effect of a liquid crystal display in accordance with a preferred embodiment of the present invention; and

FIG. 3 illustrates a flow chart of a method for improving the image-sticking effect of a liquid crystal display in accordance with a preferred embodiment of the present invention.

### DETAILED DESCRIPTION OF THE PREFERRED EMBODIMENTS

A preferred embodiment in accordance with the present invention is disclosed in details as follows, taken in conjunction with the accompanying drawings.

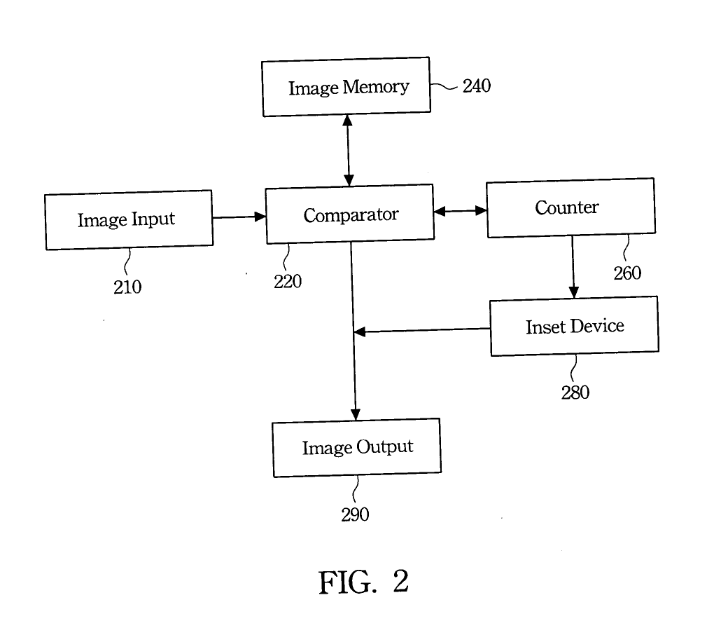

FIG. 2 shows a block diagram of an apparatus for improving the image-sticking effect of a liquid crystal display in accordance with the preferred embodiment of the present invention. As illustrated in FIG. 2, at least an image datum is transmitted by an image input device 210 continuously to a comparator 220 and is then stored in a storage, like an image memory 240. Further, the image datum represents a series of image signals transmitted therein in every frame time in the preferred embodiment. When receiving the image datum, the comparator 220 compares the image datum with a previous image datum stored in the image memory 240 first by analyzing image signals thereof between each other. As a proportion of image signals varies, for example, up to 80% of image signals of the image datum differ from those of the previous image datum, the comparator 220 regards the image datum as a moving image. When a moving image is detected, the comparator 220 transmits the image datum directly to an image output device 290. The image output device 290 may be a panel of the liquid crystal display. Otherwise, if a certain percentage of image signals of an image datum is monotonous, the image datum is considered as a still image.

On the other hand, when a still image is detected, a value of a frame counter 260 is increased by, for example, “1”. Meanwhile, an inset device 280 produces an inset image transmitted to the image output device 290 if the value of the frame counter 260 accumulates successively to a threshold value, for example, “n”, which depends on the characteristics of the liquid crystal display. Thereby the still image appearing on a panel of the liquid crystal display for a critical period is changed imperatively by displaying the inset image. The residual DC charges therein are thus offset owing to alteration of displayed pictures and hence the image-sticking effect is reduced. Further, the inset image comprises a black inset image, a white inset image, or an intermediate gray inset image.

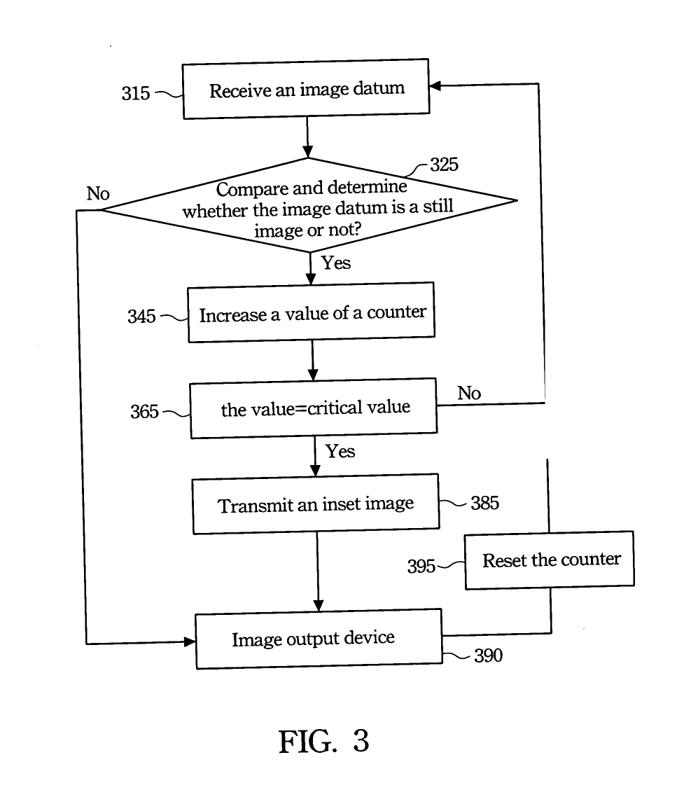

Referring to FIG. 3, which illustrates a flow chart of a method for improving the image-sticking effect of a liquid crystal display in accordance with the preferred embodiment of the present invention. After receiving an image datum in step 315, a comparator compares the image datum with a previous image datum and determines whether the image datum is a still image or not in step 325. If an image datum is not a still image, the image datum is transmitted immediately to an image output device 390 that comprises a panel of the liquid crystal display. A counter is then reset in step 395, and returns to step 315 thereafter. Or, if a still image is considered, a value of the counter is then increased by, for example, “1”, in step 345. Next, in step 365, the value of the counter is checked if the same equals a critical value, for instance, “n”, which relies on the characteristics of the liquid crystal display. At the meantime, if the value of the counter has not reached the critical value yet, then an image datum is continuously received in step 315. On the contrary, if the value of the counter is equal to the critical value, an inset image is produced by an inset device and is transmitted to the image output device 390 in step 385. Afterward the value of the counter is reset, that is, set to “0”, in step 395, the process returns to step 315. In addition, the inset image may be a black inset image, a white inset image, or an intermediate gray inset image. The still image displayed on the panel for a critical period is forced to vary by inserting the inset image. Accordingly, the residual image disappears.

According to the aforementioned preferred embodiment of the present invention, an inset image is transmitted to a panel of a liquid crystal display when a still image displayed on the panel for a certain period is detected. The image-sticking effect resulting from residual DC charges is thus improved by altering the displaying images. Therefore the residual image is diminished when the same picture has been displayed for a long time.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. An apparatus for improving the image-sticking effect of a liquid crystal display, comprising:
a comparator for comparing an image datum and a previous image datum to determine whether the image datum is a still image or not;
a counter connected to the comparator for counting a value of the still image datum; and
an inset device connected to the counter for producing an inset image when the value of the still image datum equals a threshold value.

2. The apparatus of claim 1, further comprising:
a storage connected to the comparator for storing the image datum and the previous image datum;
an image input device for transmitting the image datum to the comparator; and
an image output device connected to the comparator and the inset device for outputting the image datum and the inset image.

3. The apparatus of claim 2, wherein the image output device comprises a panel of the liquid crystal display.

4. The apparatus of claim 1, wherein the inset image comprises an intermediate gray inset image.

5. The apparatus of claim 1, wherein the inset image comprises a white inset image.

6. The apparatus of claim 1, wherein the inset image comprises a black inset image.

7. A method for improving the image-sticking effect of a liquid crystal display, comprising the steps of:
receiving an image datum;
comparing the image datum and a previous image datum to determine whether the image datum is a still image or not, and increasing a value of a counter when the image datum is a still image; and
producing an inset image to an image output device when the value equals a critical value.

8. The method of claim 7, further comprising a step of outputting the image datum directly to the image output device when the image datum is not a still image.

9. The method of claim 7, wherein the inset image comprises an intermediate gray inset image.

10. The method of claim 7, wherein the inset image comprises a white inset image.

11. The method of claim 7, wherein the inset image comprises a black inset image.

12. The method of claim 7, wherein the image output device comprises a panel of the liquid crystal display.

13. A system for improving the image-sticking effect of a liquid crystal display, comprising:
a comparator for comparing an image datum and a previous image datum to determine whether the image datum is a still image or not;
an image memory connected to the comparator for storing the image datum and the previous image datum;
a frame counter connected to the comparator for counting a value of the still image datum; and
an inset device connected to the frame counter for producing an inset image when the value of the still image datum equals a threshold value.

14. The system of claim 13, further comprising:
an image input device for transmitting the image datum to the comparator; and
an image output device connected to the comparator and the inset device for outputting the image datum and the inset image.

15. The system of claim 14, wherein the image output device comprises a panel of the liquid crystal display.

16. The system of claim 13, wherein the inset image comprises an intermediate gray inset image.

17. The system of claim 13, wherein the inset image comprises a white inset image.

18. The system of claim 13, wherein the inset image comprises a black inset image.
